(19) United States
(12) Patent Application Publication
(10) Pub. No.: US 2026/0340701 A1
(43) Pub. Date: Oct. 29, 2026

(54) Context-Aware Relevance Ranking of Search Results Based on Previous Search Queries and User Interaction Data

(71) Applicant: Maplebear Inc., San Francisco, CA (US)

(72) Inventor: Naval Shah, Toronto (CA)

(21) Appl. No.: 19/192,326

(22) Filed: Apr. 28, 2025

(51) Int. Cl. G06Q 30/0601; G06F 16/9535

(52) U.S. Cl. CPC G06Q 30/0627; G06F 16/9535; G06Q 30/0603; G06Q 30/0633

(57) ABSTRACT

A search engine provides search results based on context-aware relevance adjustments that are based on previous search queries and user interaction data. A search query is received from a user client device associated with a user. An initial ranking of search results for candidate items from an online catalog is determined based in part on the search query. Responsive to a determination that the search query is continuation of a prior search query that occurred prior to the search query, the initial ranking of the search results are adjusted based in part on adjustment factors to form an adjusted ranking of the search results. The adjustment factors include user interaction data that is based in part on user interactions with the prior search results. At least some of the search results are provided to the user client device for presentation in accordance with the adjusted ranking.

### BACKGROUND

Conventional online shopping platforms determine results for search queries received during an online session without considering context from previous related searches that occurred earlier in the online session. This can cause a conventional online shopping platform to present search results to a search query in which at least some of those search results had been previously presented in response to a prior related search query and been disregarded by the user. For example, a user may perform an initial search for “milk” using a conventional online shopping platform. The conventional online shopping platform returns a first set of results, and the user may scroll through some of them and not select any of them for purchase. As such, the user has disregarded the search results that were presented. The user may then narrow their search query, and provide a second related search query for “organic milk.” As the conventional online shopping platform does not take into account the search results previously disregarded by the user, the conventional online shopping platform may end up returning some of those previously disregarded results to the user as search results for the second related search query. Moreover, some or all of these previously disregarded results may be displayed prominently in the second set of results even though the user had previously disregarded them.

### SUMMARY

In accordance with one or more aspects of the disclosure, a search engine provides search results based on context-aware relevance adjustments that are based on previous search queries and user interaction data. An online system and a user client device that is associated with a user may be engaged in an online session. The online system receives a search query from the user device. The online system determines an initial ranking of search results for candidate items from an online catalog based in part on the search query. The online system determines whether or not the search query is a continuation of a prior search query that occurred prior to the search query. The online system, responsive to the prior search query, may have provided for presentation to the user client device prior search results to the prior search query.

In embodiments where the online system determines that the search query is not a continuation of the prior search query, the online system provides at least some of the search results to the user client device in accordance with the initial ranking. And in embodiments, where the online system determines that the search query is a continuation of the prior search query, the online system adjusts the initial ranking of the search results based in part on adjustment factors to form an adjusted ranking of the search results. The adjustment factors include user interaction data that is based in part on user interactions with the prior search results. The online system provides at least some of the search results to the user device in accordance with the adjusted ranking.

The online system may be able to adjust rankings of search results for related searches based on how the user interacted with the prior search results of the prior queries. In this manner, the online system is able to customize the initial ranking of search results for a search query based on context gathered over multiple search queries. For example, the online system may down-rank a search result that was also presented as one of the previous search results and disregarded (e.g., not added to an ordering list) by the user. Accordingly, the online system is able to adjust rankings of search results to quickly align rankings of search results with an intent behind a plurality of related search results.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIG. 3 illustrates an example block diagram describing adjusting rankings of search results to a search query using a ranking adjustment model of an online system, in accordance with some embodiments.

FIGS. 4A and 4B form an example sequence diagram describing an online system that provides context aware relevance adjustment of search results, in accordance with some embodiments.

FIG. 5 is a flowchart for a method of context aware relevance adjustment to search result ranking based in part on a prior search query and associated user interaction data, in accordance with some embodiments.

### DETAILED DESCRIPTION

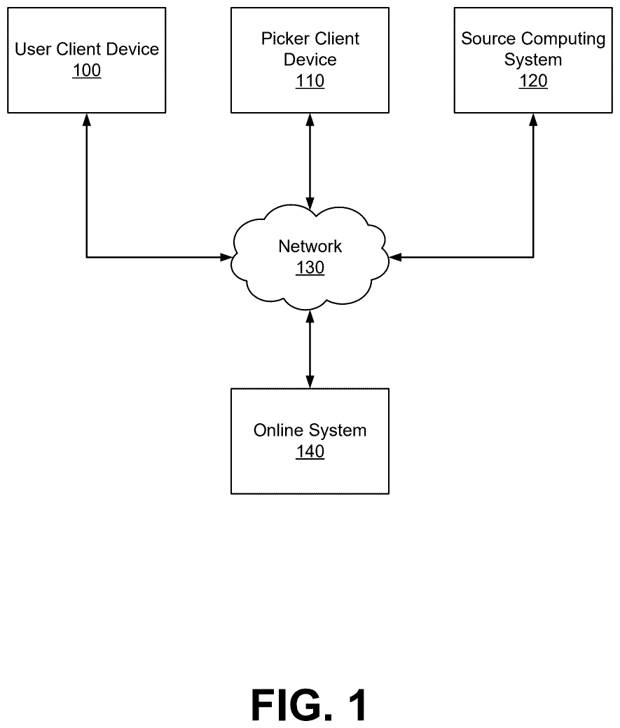

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be referred to as a “user device.” The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items (e.g., via search queries) that are available through the online system 140. For example, the user may provide a search query for an item using the ordering interface. The user client device 100 provides the search query to the online system 140. The user client device 100 receives search results for the search query from the online system 140. The search results are, e.g., recommendations for items that are available for purchase from an online catalog. The ordering interface presents the search results in accordance with a ranking of the results. The user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The ordering interface collects user interaction data based on interactions of the user with the search results (e.g., recommendations for items). User interaction data describes interactions of the user with the search results. User interaction data may include, e.g., visibility metrics (e.g., whether or not a search result is below the fold or above the fold), engagement indicators (e.g., cursor movements over search results), dwell time (e.g., time the user spends viewing the search results), item actions (e.g., impressions), some other data based on interactions of the user with the search results, or some combination thereof. The user client device 100 provides the collected user interaction data to the online system 140.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. An online shopping session (online session) may be established between the online system 140 and a user client device 100 associated with a user. During the online session, the online system 140 may receive a search query from the user client device 100. The online system 140 may determine an initial ranking of search results for candidate items from the online catalog based in part on the search query. The online system 140 determines whether the search query is a continuation (e.g., a related narrower search) of a prior search query. As used herein, a “related” search query is a search query that is a continuation of a prior search query. The prior search query may have occurred during the online session. In some embodiments, the prior search query may have occurred as part of a prior online session that occurred within a time threshold of the search query. Longer periods between online sessions generally correlate with decreased chances of search queries being related, e.g., as such the time threshold may be relatively short (e.g., a day or less). In some embodiments, a related prior search query may be the last search query received from the user client device before the search query. In some embodiments, there may be one or more intervening search queries between a related prior search query and the search query. In embodiments, where the search query is not a continuation of a prior search, the online system 140 provides the search results to the user client device 100, wherein the search results are presented (e.g., via display or via audio dictation) in accordance with the initial ranking. The online system 140 may receive user interaction data from the user client device 100 that describes the user's interactions (e.g., dwell time, impressions, which items were presented, etc.) with the search results.

In contrast, in cases where the search query is a continuation of one or more prior search queries (e.g., that occurred during the online session), the online system 140 adjusts the initial ranking of the search results based in part on adjustment factors to form an adjusted ranking of the search results. The adjustment factors include user interaction data associated with one or more prior search queries that the search query is a continuation of. For example, a search result for a prior search query may also be a search result to the search query. The online system 140 may use the interaction data to determine that the user had previously viewed the search result as one of the prior search results for the prior search query and elected not to add it to the ordering list. The online system 140 may then adjust a score for the search result such that the search result is ranked lower (i.e., less prominent in the search results) in the adjusted ranking than in the initial ranking. In another example, the search result for the prior search query is also a search result to the search query, but was not previously presented by the user client device. And a score of the search result is higher for the search query than a prior score for the search result was for the prior search query. As such, the online system 140 may adjust the score for the search result such that the search result is ranked higher (i.e., more prominent in the search results) in the adjusted rankings than in the initial ranking. The online system 140 may provide some or all of the search results to the user client device 100 in accordance with the adjusted ranking. The user client device 100 may present (e.g., via display or via audio dictation) the search results in accordance with the adjusted ranking.

The online system 140 is able to adjust rankings of search results for related searches based on how the user interacted with the prior search results of the prior queries. In this manner, the online system 140 is able to adjust an initial ranking of search results for a search query based on context gathered over multiple search queries. For example, the online system 140 may down-rank a search result that was also presented as one of the previous search results and disregarded (e.g., not added to an ordering list) by the user. Accordingly, the online system 140 is able to adjust rankings of search results to quickly align rankings of search results with an intent behind a plurality of related search results (e.g., user is looking for a particular item but is not sure how to word the search query). Moreover, this can prevent instances where items that were previously disregarded by the user in prior search results (of a related prior search) would continue to be prominently presented as part of a current set of search results for a current search query—a situation that can occur if using a conventional online shopping platform.

Once an ordering list is complete, the online system 140 may receive an order for items that are part of the ordering list from the user client device 100. The online system 140 receives orders from the user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

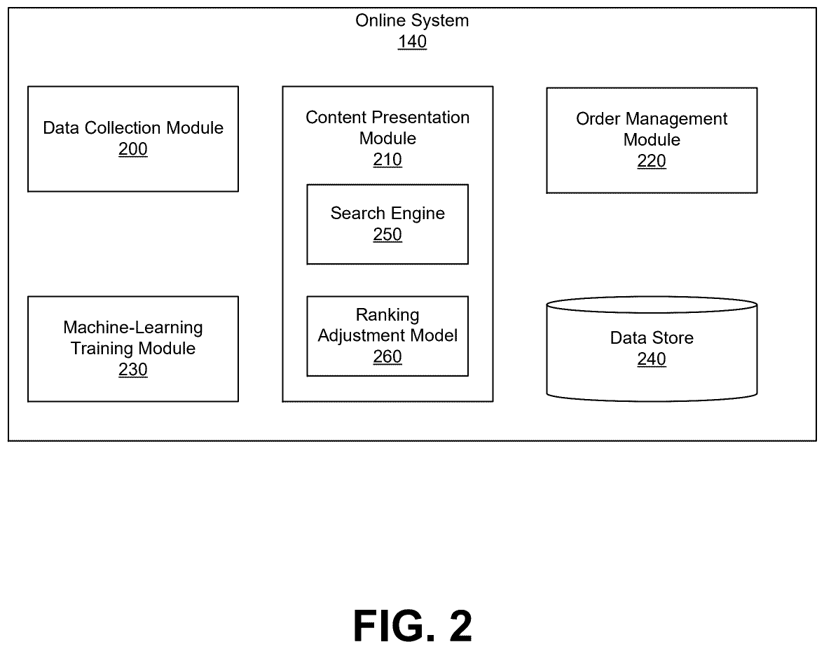

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects user interaction data from user client devices. User interaction data may include, e.g., visibility metrics, engagement indicators, dwell time, item actions, some other data based on interactions of the user with the search results, or some combination thereof. Visibility metrics describe whether or not a search result is visible on a screen of a user client device or has been presented via audio dictation. A search result that is visible or has been presented via audio dictation may be referred to as being “above the fold,” and a search result that is not yet visible (e.g., has not been scrolled to yet) or had not yet been presented via audio dictation may be referred to as being “below the fold.” Engagement indicators describe actions that can be used to indicate engagement of the user with the search results. Engagement indicators may include, e.g., cursor movements over search results, scrolling patterns, clicks, etc. Dwell time describes an amount of time the user spends viewing the search results, specific search results, or some combination thereof. Item actions describe whether the user clicked into an item of the search result for more details (e.g., impressions), added an item from the search results to their ordering list, etc. User interaction data may be associated with a particular search query and corresponding set of search results, an online session, a user, or some combination thereof.

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The content presentation module 210 processes search queries from user client devices using a search engine 250. The search engine 250 may use some or all of the above techniques (e.g., item selection model, score items based on search query, score items based on availability) to score candidate items from the online catalog as search results in response to a received search query. The search engine 250, for a given search query, may then rank the scored items. This ranking may be referred to as an initial ranking of the search results.

The content presentation module 210 determines whether a search query, of an online session with a user client device 100, is a continuation of a prior search query received from the user client device 100 (e.g., during the online session or a prior online session).

Triggering conditions are conditions that if met are indicative that a search query is a continuation of at least one prior search history of the online session. A triggering condition may be, e.g., that the search query and a prior search query are associated with a same item category; that text of the search query has at least a threshold similarity with text of a prior search query; that there is a threshold overlap in search results for the search query and prior search results for a prior search query; that the user did not add an item to their ordering list from prior search results that were presented in response to one of the prior search queries; that there is a match of the search query and one or more of the prior search queries to a same hierarchical taxonomy (e.g., that are part of a same item category); some other way of determining whether the search query is a continuation of another prior search query of the online session; or some combination thereof.

The content presentation module 210 may determine triggering values for one or more triggering conditions, and make the determination whether the search query is a continuation of a prior search query based in part on the determined triggering values. In some embodiments where there are triggering values for multiple triggering conditions, the content presentation module 210 may determine a triggering value that is a weighted combination of the triggering values of the multiple triggering conditions. The content presentation module 210 may then determine whether the search query is a continuation of a prior search query of the online session based on a comparison of the triggering value to a threshold value.

In some instances a search query is a continuation of a prior search query (e.g., that occurred during the online session or a prior online session that is within a time threshold of the online session). For example, the search query may be a narrower search within a same item category of the prior search query, or the search query may be a broader search within the same item category of the prior search query. For example, a prior search query received during an online session with a user client device 100 may have been for “milk,” and a search query for “organic milk” is received as part of the online session (or vice versa). The content presentation module 210 may determine that the search query for “organic milk” is a continuation of the prior search query for “milk,” using some or all of the techniques described above (e.g., both are for items that fall within a same hierarchical taxonomy for milk). Conversely, if the search query was for “watermelon,” the content presentation module 210 may determine that the search query is not a continuation of the prior search query for “milk.”

In some embodiments, a triggering condition may be that at least some of the prior search results were presented (e.g., via display or audio dictation) for at least a threshold period of time. For example, if the content presentation module 210 determines that the user spent less than a threshold period of time (e.g., 1 or 2 seconds) reviewing the prior search results, the content presentation module 210 may automatically determine that the search query is not a continuation of the search query. In these embodiments the determination that the search query is not a continuation of the prior search query can occur despite potentially satisfying other triggering conditions (e.g., a match of the search query and the prior search query to a same hierarchical taxonomy) that would indicate otherwise. For example, in instances where the user does not spend meaningful time reviewing the prior search results, there is may be little user interaction data that is collected, thereby, resulting in little to no change in the ranking of the search results that were previously presented as part of the prior search results.

In some instances, the content presentation module 210 determines that a search query of an online session is not a continuation of one or more prior search queries of the online session. Responsive to this determination, the content presentation module 210 provides some or all of the search results to the user client device 100 in accordance with the initial ranking. For example, the content presentation module 210 may update the ordering interface with the search results to the search query based on the initial ranking of the search results, and provide the ordering interface with the search results to the user client device 100. In this manner, the search results are presented via the user client device 100 to the user in accordance with the initial ranking.

In some instances, the content presentation module 210 may determine that the search query of the online session is a continuation of the one or more prior search queries of the online session. Responsive to this determination, the content presentation module 210 adjusts the initial ranking of the search results based in part on adjustment factors to form an adjusted ranking of the search results. The adjustment factors may include, e.g., the one or more prior search queries of the online session that are related to the search query, rankings or scoring of prior search results that were provided to the user client device 100 for the one or more prior search queries, user interaction data associated with the one or more prior search queries, or some combination thereof.

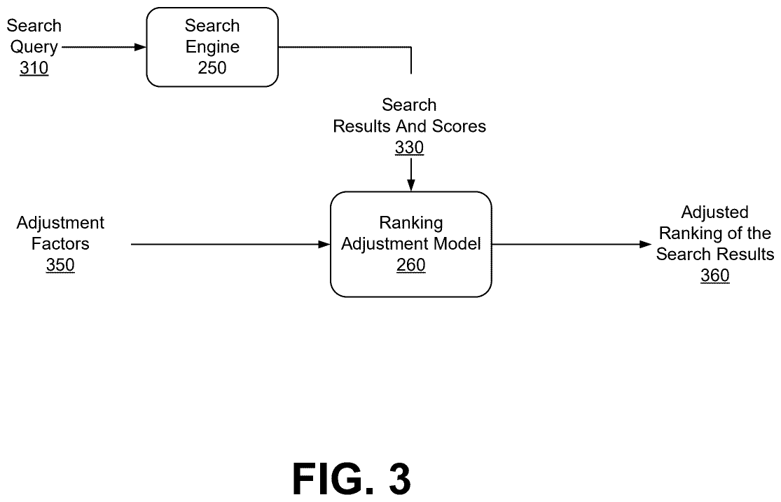

The content presentation module 210 may use a ranking adjustment model 260 to adjust the initial rankings of the search results. In some embodiments, the ranking adjustment model 260 is a machine learning model. In other embodiments, the ranking adjustment model 260 may be rule based. The content presentation module 210 may apply the search results and their original scores with some or all of the adjustment factors to the ranking adjustment model 260. The ranking adjustment model 260 adjusts scores for some or all of the search results based, at least in part, on the adjustment factors to generate an adjusted ranking for the search results. The content presentation module 210 provides (e.g., via the ordering interface) at least some of the search results to the user device in accordance with the adjusted ranking. In this manner, the search results may be presented (via the user client device 100) to the user in accordance with the adjusted ranking. Operation of the ranking adjustment model 260 is further described in detail below with regard to FIG. 3.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140 (e.g., the ranking adjustment model 260). The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, order data, or user interaction data, which may be referred to respectively as training user data, training picker data, training item data, training order data, and training user interaction data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

Training examples may include training data that, e.g., describes a first set of cases where a search query is a continuation of a prior search query (e.g., within a same online session) and engagement data for search results associated with the search query; and describes a second set of cases where the search query of an online session is not a continuation of any prior search query and engagement data for search results associated with the search query. The machine-learning training module 230 may compare the engagement data for the first set of cases to the engagement data of the second set of cases, and use the difference to train the ranking adjustment model 260.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, picker data, search queries, adjustment factors (e.g., user interaction data), initial rankings of search results of search queries, and adjusted rankings of the search results for use by the online system 140. The data store 240 also stores trained machine-learning models (e.g., the ranking adjustment model 260) trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 illustrates an example block diagram describing adjusting rankings of search results to a search query using the ranking adjustment model 260 of the online system 140, in accordance with some embodiments. Alternative embodiments may include more, fewer, or different actions from those illustrated in FIG. 3, and the functionality of each component may be divided between the components differently from the description below.

In FIG. 3, a search query 310 is a continuation of a prior search query. The search query 310 is received from a user client device (e.g., the user client device 100) associated with a user. The user client device is in an online session with the online system 140. The search query 310 is applied to the search engine 250. The search engine 250 outputs search results and scores 330 the search results. Each of the search results may correspond to a candidate item from the online catalog of the online system 140 and have an associated score. The search results may be ordered in accordance with their associated scores to form an initial ranking of the search results.

The content presentation module 210 applies the search results and scores 330 and adjustment factors 350 to the ranking adjustment model 260. In the illustrated example, the adjustment factors include the prior search query of the online session, the search query 310, rankings or scores of prior search results that were provided to the user client device 100 for the prior search query, and user interaction data associated with the prior search query, or some combination thereof.

The ranking adjustment model 260 adjusts scores for some or all of the search results based in part on the adjustment factors 350 to generate an adjusted ranking for the search results 360. For example, the ranking adjustment model 260 may identify a first set of one or more of the prior search results that were presented (e.g., viewed or output via audio dictation) and not selected by the user using the user interaction data. For example, the user client device 100 may have been presenting the previous search results via audio dictation. The user may have interrupted the presentation after the one or more of the prior search results were presented, and provided a voice command to perform the search query.

The ranking adjustment model 260 may identify a second set of one or more of the search results that are also part of the first set. For example, if the first set includes a search result for a first candidate item, and the first candidate item is also one of the search results, the first candidate item would be part of the second set. The ranking adjustment model 260 may, e.g., reduce (i.e., down-rank) scores associated with the search results that are part of the second set. Continuing with the above example, the ranking adjustment model 260 may reduce a score of the first candidate item as it is part of the second set.

The amount of score reduction may differ based in part on the user interaction data. The ranking adjustment model 260 may, e.g., reduce a score associated with a search result that was presented (e.g., determined from the user interaction data) as part of the prior search results by a first adjustment amount (e.g., −10% of the score). And for cases where a search result was presented as part of the prior search results, a cursor of the user client device was scrolled over the search result (e.g., may be determined from the user interaction data), and the search result was not added to the ordering list (e.g., may be determined from the user interaction data), the ranking adjustment model 260 may, e.g., reduce the score of the search result by a second adjustment amount (e.g., −20% of the score) that is larger than the first adjustment amount. Likewise, for cases where a search result was presented as part of the prior search results, the search result was selected (e.g., clicked into), and the search result was not added to the ordering list, the ranking adjustment model 260 may, e.g., reduce a score of the search result by a third adjustment amount (e.g., −30% of the score) that is larger than the first and second adjustment amounts. Accordingly, the ranking adjustment model 260 is able to de-emphasize search results that the user has previously expressly or implicitly disregarded in the online session or in a previous search query.

The ranking adjustment model 260 may also determine (e.g., using the user interaction data) a third set of one or more of the prior search results that describe any prior search results that were not presented (e.g., below the fold). The ranking adjustment model 260 may determine a fourth set of one or more of the search results that are also part of the third set. The ranking adjustment model 260 may identify any search results in the fourth set whose scores are higher in the fourth set than in the third set. The scores may be higher if, e.g., the search result more closely aligns with the search query than the prior search query. The ranking adjustment model 260 may increase scores (i.e., up-rank) of the identified search results by a positive adjustment amount. In some embodiments, the positive adjustment amount is a fixed value (e.g., +10% of score). In other embodiments, positive adjustment about may be based in part on how much higher the score is for the search result than for the score of corresponding prior search result.

In some cases, the ranking adjustment model 260 may make no adjustment to a score of a search result. For example, the ranking adjustment model 260 may not adjust a score of a search result that is not one of the prior search results (i.e., not part of the first set or the third set). In another example, the ranking adjustment model 260 may not adjust the score of a search result that is part of the second set and was presented (e.g., above the fold) for less than a threshold period of time (e.g., less than a 1 second).

As described above, the ranking adjustment model 260 may adjust the scores of the search results based in part on the adjustment factors 350. By adjusting at least some of the scores of the search results, the ranking adjustment model 260 adjusts the initial ranking of the search results to form the adjusted ranking of the search results 360. The adjusted ranking of the search results may act to (1) emphasize search results that align with the search query; or (2) de-emphasize search results that had previously been discarded by the user during the online session. In this manner, the ranking adjustment model 260 provides context aware relevance adjustment to the search results that is based in part on the previous search query and associated user interaction data.

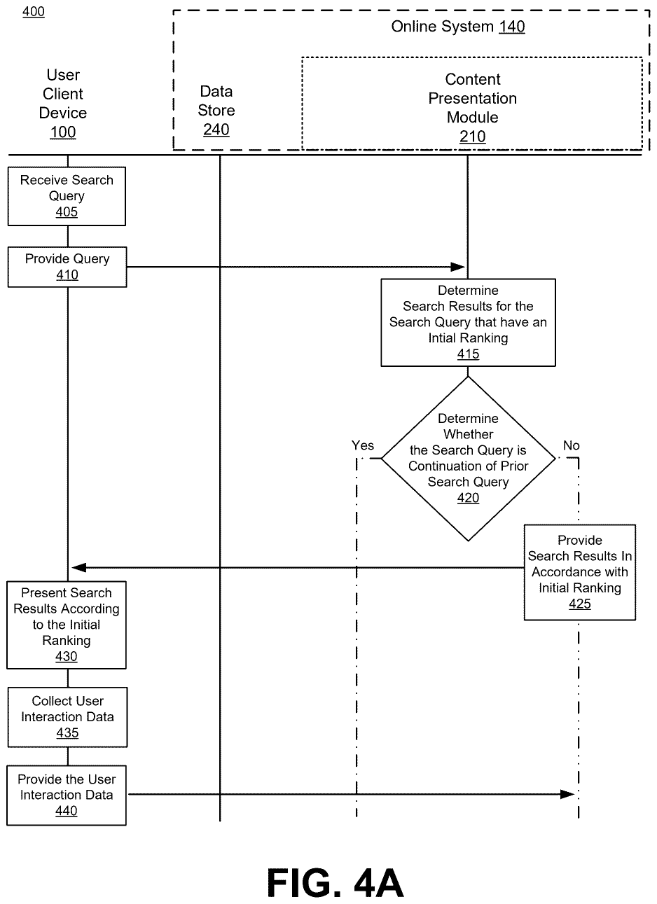

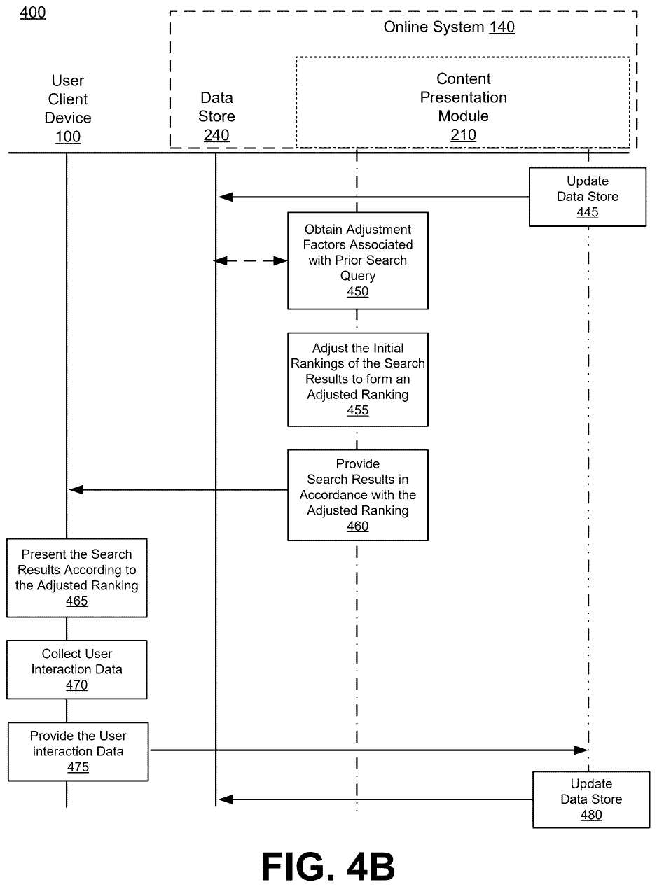

FIGS. 4A and 4B form an example sequence diagram 400 describing an online system 140 that provides context aware relevance adjustment of search results, in accordance with some embodiments. The online system 140 is an embodiment of the online system 140. Alternative embodiments may include more, fewer, or different interactions from those illustrated in FIGS. 4A-4B, and the steps may be performed in a different order from that illustrated in FIGS. 4A-4B.

A user client device 100 receives 405 a search query from a user. The search query may be received as part of an online session between the online system 140 and the user client device 100. The user client device 100 provides 410 (as part of the online session) the search query to the online system 140.

A content presentation module 210 of the online system 140 determines 415 search results for the search query that have an initial ranking. The content presentation module 210 is an embodiment of the content presentation module 210. Each of the search results have a respective score, and the scores are used to form the initial ranking of the search results. The content presentation module 210 may apply the search query to a search engine (e.g., the search engine 250) to determine the search results and their associated scores. In some embodiments, the content presentation module 210 may update a data store 240 with the search query, the search results, and the initial ranking. The data store 240 is an embodiment of the data store 240.

The content presentation module 210 determines 420 whether the search query is a continuation of a prior search query. The prior search query may have occurred during the online session or a prior online session that is within a time threshold of the online session. The content presentation module 210 may determine triggering values for one or more triggering conditions, and make the determination whether the search query is a continuation of a prior search query based in part on the determined triggering values. In some embodiments where there are values for multiple triggering conditions, the content presentation module 210 may determine a triggering value that is a weighted combination of the triggering values of the multiple triggering conditions. The content presentation module 210 may then determine whether the search query is a continuation of a prior search query based on a comparison of the triggering value to a threshold value.

In some instances, the content presentation module 210 may determine that the search query is not a continuation of a prior search query in the online session. For example, the content presentation module 210 may determine that the triggering value does not exceed the threshold value.

Responsive to a determination that the search query is not a continuation of a prior search query in the online session, the online system 140 provides 425 the search results in accordance with the initial ranking to the user client device 100. For example, the content presentation module 210 may update the ordering interface with the search results in accordance with the initial ranking, and the online system 140 provides the updated ordering interface to the user client device 100.

The user client device 100 presents 430 the search results according to the initial ranking. For example, the user client device 100 may present (e.g., via display or audio dictation) a highest ranked search result first, a second highest ranked search result next, and so on and so forth. A display area of the user client device 100 may present groups of search results at a same time. In these instances, the user client device 100 may present the group of search results according to the initial ranking. For example, if a group includes three slots, the user client device 100 first presents the three highest ranking search results, and the user can then scroll to see other search results of increasing lower rank.

Concurrent with presenting the search results, the user client device 100 collects 435 user interaction data. For example, the user client device 100 may determine user interaction data like, e.g., visibility metrics, engagement indicators, dwell time, item actions, etc., for the presented search results. The user client device 100 may provide 440 the user interaction data to the online system 140.

With reference to FIG. 4B, the content presentation module 210 may update 445 the data store 240 with the user interaction data. The user interaction data may be used for adjusting rankings of search results for later search queries of the online session that are a continuation of the search query.

Turning back to step 420 in FIG. 4A, in some instances, the content presentation module 210 may determine that the search query is a continuation of a prior search query in the online session. For example, the content presentation module 210 may determine that the triggering value does exceed the threshold value.

Responsive to a determination that the search query is a continuation of a prior search query in the online session, the content presentation module 210 obtains 450 adjustment factors associated with the prior search query, as shown in FIG. 4B. For example the content presentation module 210 may obtain the adjustment factors (e.g., rankings or scoring of prior search results that were provided to the user client device 100 for the prior search query, and user interaction data associated with the prior search query) from the data store 240.

The content presentation module 210 adjusts 455 the initial ranking of the search results to form an adjusted ranking of the search results. The content presentation module 210 may adjust the initial ranking of the search results, by applying the search results and their associated scores and the adjustment factors to a ranking adjustment model (e.g., the ranking adjustment model 260). The ranking adjustment model may adjust the scores of some or all of the search results based in part on the adjustment factors. For example, the ranking adjustment model may increase scores for search results that both align with the search query and have not been previously presented to the user as one of the prior search results for more than a threshold period of time; and decrease scores for search results that had previously been presented as part of the prior search results for at least a threshold period of time, but were not added to the ordering list. In this manner, the ranking adjustment model adjusts scores of at least some of the search results such that the search results have an adjusted ranking that is different from the initial ranking. The search results are provided 460 to the user client device 100 in accordance with the adjusted ranking.

The user client device 100 presents 465 the search results according to the adjusted ranking. This step is substantially similar to step 430 except that the search results are presented in accordance with the adjusted ranking instead of the initial ranking.

Concurrent with presenting the search results, the user client device 100 collects 470 user interaction data. The user client device 100 provides 475 the user interaction data to the online system 140. The content presentation module 210 may update 480 the data store 240 with the user interaction data. Steps 470, 475, and 480 are substantially similar to steps 435, 440, and 445, respectively, except they are dealing with user interaction data associated with the presentation of the search results in accordance with the adjusted ranking.

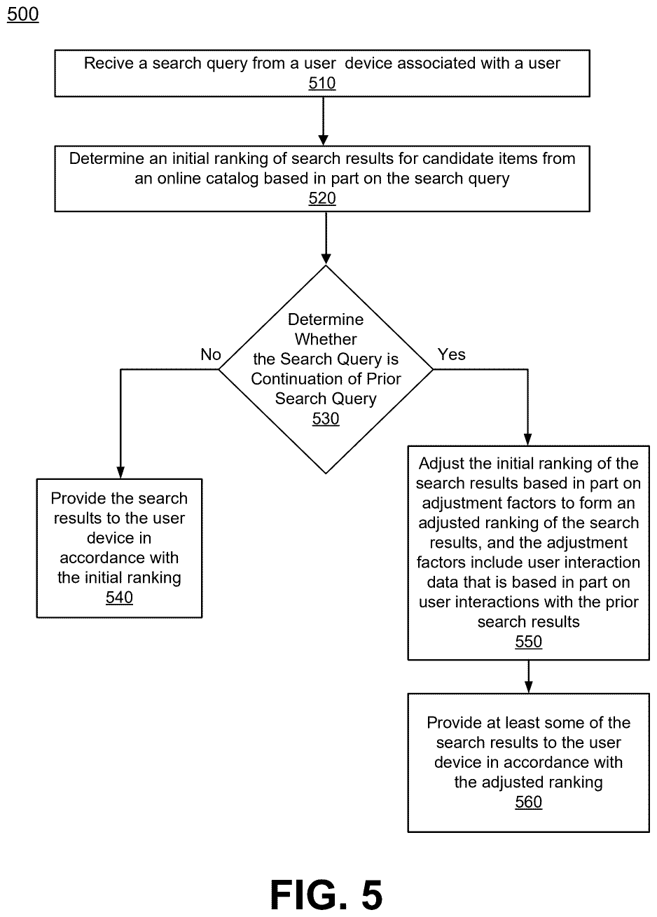

FIG. 5 is a flowchart for a method of context aware relevance adjustment to search result rankings based in part on a prior search query and associated user interaction data, in accordance with some embodiments. Alternative embodiments may include more, fewer, or different steps from those illustrated in FIG. 5, and the steps may be performed in a different order from that illustrated in FIG. 5. These steps may be performed by an online system (e.g., online system 140). Additionally, each of these steps may be performed automatically by the online system without human intervention.

The online system 140 receives 510 a search query from a user device (e.g., the user client device 100) associated with a user. The user device may be engaged in an online session with the online system. The search query may be, e.g., for “ginger powder.”

The online system determines 520 an initial ranking of search results for candidate items from an online catalog based in part on the search query. The online system may apply the search query to a search engine (e.g., the search engine 250) to obtain the search results and associated scores. The online system (e.g., the search engine 250) may rank the search results in accordance with their scores to obtain an initial ranking for the search results.

The online system determines 530 whether the search query is a continuation of a prior search query. The prior search query may have occurred during the online session or a prior online session that is within a time threshold of the online session (e.g., 1 day or less). The content presentation module may determine triggering values for one or more triggering conditions, and make the determination based in part on the determined triggering values. For example, the online system may determine a triggering value that is a weighted combination of the triggering values of the triggering conditions. The online system may determine whether the search query is a continuation of a prior search query based on a comparison of the triggering value to a threshold value. For example, if the triggering value does not meet the threshold value, the online system may determine that the search query is not a continuation of a prior search query of the online session. Likewise, if the triggering value meets or exceeds the threshold value, the online system may determine that the search query is a continuation of a prior search query of the online session.

Responsive to a determination that the search query is not a continuation of a prior search query in the online session (e.g., the prior search query was for “milk” and the search query is for “ginger powder”), the online system provides 540 the search results to the user device in accordance with the initial ranking. For example, the online system may update the ordering interface with the search results in accordance with the initial ranking, and the online system provides the updated ordering interface to the user device.

Conversely, responsive to a determination that the search query is a continuation of a prior search query (e.g., the prior search query was for “ginger” and the search query is for “ginger powder”), the online system adjusts 550 the initial ranking of the search results based in part on adjustment factors to form an adjusted ranking of the search results. The online system obtains (e.g., from the data store 240) the adjustment factors associated with prior search results for the prior search query. The adjustment factors include user interaction data that is based in part on user interactions with the prior search results. The online system may apply the search results, scores of the search results, and the adjustment factors (e.g., the user interaction data) to a ranking adjustment model (e.g., the ranking adjustment model 260) that outputs an adjusted ranking for the search results.

The online system provides 560 at least some of the search results to the user device in accordance with the adjusted ranking. The user device presents the search results in accordance with the adjusted ranking. In this manner, the user is presented with the most relevant search results first, where the relevancy is determined in part from context derived from the user interaction data associated with the prior search results. This may improve a likelihood that the user finds what they are searching for quickly.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
receiving a search query from a user device associated with a user;
generating an initial ranking of search results for candidate items from an online catalog based in part on the search query;
detecting that the search query is a continuation of a prior search query that occurred before the search query, wherein prior search results to the prior search query were previously provided to the user device for presentation;
adjusting the initial ranking of the search results based in part on one or more adjustment factors to form an adjusted ranking of the search results, wherein the adjustment factors include user interaction data that is based in part on user interactions with the prior search results;
selecting at least some of the search results based on the adjusted ranking; and
transmitting the selected search results to the user device, wherein the transmitting causes the user device to display the selected search results.

2. The method of claim 1, further comprising:
transmitting at least some of the prior search results to the user device, wherein one or more of the prior search results are presented to the user, and the user device collects the user interaction data associated with the presentation of the one or more of the prior search results; and
receiving the user interaction data from the user device.

3. The method of claim 1, wherein adjusting the initial ranking of the search results based in part on the adjustment factors to form the adjusted ranking of the search results, further comprises:
down-ranking search results, of the search results, that were previously presented to the user as part of the prior search results and not added to an ordering list.

4. The method of claim 1, wherein adjusting the initial ranking of the search results based in part on the adjustment factors to form the adjusted ranking of the search results, further comprises:
determining a first set of one or more of the prior search results that were not presented by the user device;
determining a second set of one or more of the search results that are also part of the first set;
identifying a search result in the second set whose score is higher in the second set than in the first set; and
up-ranking the identified search result.

5. The method of claim 1, wherein determining that the search query is a continuation of the prior search query that occurred prior to the search query further comprises:
determining a triggering value that is based in part on meeting one or more triggering conditions.

6. The method of claim 5, wherein the one or more triggering conditions include a first triggering condition that there is a match of the search query and the prior search query to a same hierarchical taxonomy, and a second triggering condition that at least some of the prior search results were presented for at least a threshold period of time.

7. The method of claim 1, further comprising:
receiving from the user device a request to add an item corresponding to one of the search results to an ordering list associated with the user;
receiving a subsequent search query from the user device;
determining that the subsequent search query is not related to the prior search query or the search query based in part on the request to add the item to the ordering list;
determining a second initial ranking of second search results for candidate items from the online catalog based in part on the subsequent search query; and
transmitting at least some of the second search results to the user device in accordance with the second initial ranking.

8. The method of claim 1, wherein the user device presented a first portion of the prior search results via audio dictation before receiving a voice command from the user to perform the search query, and wherein adjusting the initial ranking of the search results based in part on the adjustment factors to form the adjusted ranking of the search results, further comprises:
down-ranking search results of the search results that were also part of the first portion of the prior search results.

9. The method of claim 1, wherein the adjustment factors also include scores used to rank the prior search results, and the prior search query, and wherein adjusting the initial ranking of the search results based in part on the adjustment factors to form the adjusted ranking, further comprises:
applying the adjustment factors and scores used to determine the initial ranking of search results to a machine learning model that outputs the adjusted ranking of the search results.

10. A computer program product comprising a non-transitory computer readable storage medium having instructions encoded thereon that, when executed by a processor of a computer system, cause the computer system to perform steps comprising:
receiving a search query from a user device associated with a user;
generating an initial ranking of search results for candidate items from an online catalog based in part on the search query;
detecting that the search query is a continuation of a prior search query that occurred before the search query, wherein prior search results to the prior search query were previously provided to the user device for presentation;
adjusting the initial ranking of the search results based in part on one or more adjustment factors to form an adjusted ranking of the search results, wherein the adjustment factors include user interaction data that is based in part on user interactions with the prior search results;
selecting at least some of the search results based on the adjusted ranking; and
transmitting the selected search results to the user device, wherein the transmitting causes the user device to display the selected search results.

11. The computer program product of claim 10, further comprising encoded instructions that when executed cause the computer system to perform steps comprising:
transmitting at least some of the prior search results to the user device, wherein one or more of the prior search results are presented to the user, and the user device collects the user interaction data associated with the presentation of the one or more of the prior search results; and
receiving the user interaction data from the user device.

12. The computer program product of claim 10, wherein the encoded instructions for adjusting the initial ranking of the search results based in part on the adjustment factors to form the adjusted ranking of the search results, cause the computer system to perform steps comprising:
down-ranking search results, of the search results, that were previously presented to the user as part of the prior search results and not added to an ordering list.

13. The computer program product of claim 10, wherein the encoded instructions for adjusting the initial ranking of the search results based in part on the adjustment factors to form the adjusted ranking of the search results cause the computer system to perform steps comprising:
determining a first set of one or more of the prior search results that were not presented by the user device;
determining a second set of one or more of the search results that are also part of the first set;
identifying a search result in the second set whose score is higher in the second set than in the first set; and
up-ranking the identified search result.

14. The computer program product of claim 10, wherein the encoded instructions for determining that the search query is a continuation of the prior search query that occurred prior to the search query cause the computer system to perform steps comprising:
determining a triggering value that is based in part on meeting one or more triggering conditions.

15. The computer program product of claim 14, wherein the one or more triggering conditions include a first triggering condition that there is a match of the search query and the prior search query to a same hierarchical taxonomy, and a second triggering condition that at least some of the prior search results were presented for at least a threshold period of time.

16. The computer program product of claim 10, further comprising encoded instructions that when executed cause the computer system to perform steps comprising:
receiving from the user device a request to add an item corresponding to one of the search results to an ordering list associated with the user;
receiving a subsequent search query from the user device;
determining that the subsequent search query is not related to the prior search query or the search query based in part on the request to add the item to the ordering list;
determining a second initial ranking of second search results for candidate items from the online catalog based in part on the subsequent search query; and
transmitting at least some of the second search results to the user device in accordance with the second initial ranking.

17. The computer program product of claim 10, wherein the user device presented a first portion of the prior search results via audio dictation before receiving a voice command from the user to perform the search query, and wherein the encoded instructions for adjusting the initial ranking of the search results based in part on the adjustment factors to form the adjusted ranking of the search results cause the computer system to perform steps comprising:
down-ranking search results of the search results that were also part of the first portion of the prior search results.

18. The computer program product of claim 10, wherein the adjustment factors also include scores used to rank the prior search results, and the prior search query, and wherein the encoded instructions for adjusting the initial ranking of the search results based in part on the adjustment factors to form the adjusted ranking cause the computer system to perform steps comprising:
applying the adjustment factors and scores used to determine the initial ranking of search results to a machine learning model that outputs the adjusted ranking of the search results.

19. A computer system comprising:
a processor; and
a non-transitory computer readable storage medium having instructions encoded thereon that, when executed by the processor, cause the computer system to perform steps comprising:
receiving a search query from a user device associated with a user;
generating an initial ranking of search results for candidate items from an online catalog based in part on the search query;
detecting that the search query is a continuation of a prior search query that occurred before the search query, wherein prior search results to the prior search query were previously provided to the user device for presentation;
adjusting the initial ranking of the search results based in part on one or more adjustment factors to form an adjusted ranking of the search results, wherein the adjustment factors include user interaction data that is based in part on user interactions with the prior search results;
selecting at least some of the search results based on the adjusted ranking; and
transmitting the selected search results to the user device, wherein the transmitting causes the user device to display the selected search results.

20. The computer system of claim 19, wherein the encoded instructions for adjusting the initial ranking of the search results based in part on the adjustment factors to form the adjusted ranking of the search results cause the computer system to perform steps comprising:
down-ranking search results, of the search results, that were previously presented to the user as part of the prior search results and not added to an ordering list.
